(19) United States
(12) Patent Application Publication
(10) Pub. No.: US 2023/0331446 A1
(43) Pub. Date: Oct. 19, 2023

(54) TABLE TOP DISPENSERS WITH ANTI-REFILL AND ANTI-TAMPERING MECHANISMS

(71) Applicant: GOJO Industries, Inc., Akron, OH (US)

(72) Inventors: Nick E. Ciavarella, Seven Hills, OH (US); Steven Matsko, Hartville, OH (US)

(21) Appl. No.: 18/295,450

(22) Filed: Apr. 4, 2023

Related U.S. Application Data
(60) Provisional application No. 63/330,815, filed on Apr. 14, 2022.

(51) Int. Cl. B65D 49/00; B65D 51/16; B05B 11/10; B05B 11/00; B65B 51/04

(52) U.S. Cl. CPC B65D 49/00; B65D 51/1622; B65D 51/1611; B05B 11/1045; B05B 11/0044; B65B 51/04; B05B 11/1046

(57) ABSTRACT

Exemplary embodiments of tabletop dispenser having reassembly prevention devices are disclosed herein. An exemplary dispenser includes a container that has a neck. The neck having an inside neck diameter. A pump, a closure and a reassembly prevention device are also included. The reassembly prevention device is located between the closure and the pump. The reassembly prevention device has one or more members having a biased position and an unbiased position. When the one or more members are in the biased position, the outside diameter of the one or more members is less than the inside diameter of the neck. When the one or more members are in the unbiased position, the outside diameter of the one or more members is greater than the inside diameter of the neck. When the dispenser is assembled and the pump and reassembly prevention member are secured to the bottle by the closure, the reassembly prevention device is positioned inside the container neck and the reassembly prevention device is in the biased condition. When the pump and the reassembly prevention member are removed from the container neck, the one or more members to move to the unbiased position.

### RELATED APPLICATIONS

This application claims priority to and the benefits of U.S. Provisional Patent Application Ser. No. 63/330,815, titled Table Top Dispensers With Anti-Refill and Anti-Tampering Mechanisms, filed on Apr. 14, 2022, and which is incorporated herein in its entirety.

### TECHNICAL FIELD

The present invention relates generally to table top dispensers and more particularly to table top dispensers having a pump

### BACKGROUND OF THE INVENTION

Dispensers, such as, for example, soap and sanitizer dispensers, often include a pump that is connected to the bottle after the bottle is filled with the soap or hand sanitizer. Typically, the bottle includes a label that identifies the product contained in the bottle and the producer of that product. When the bottle is emptied, the pump can be removed, and the bottle refilled or recycled. Refilling the bottle with a product or brand of product that differs from the product or brand identified on the label of the bottle can lead to customer confusion and, if sub-standard product is used, the consumer may not receive the expected benefit, and/or any benefit. This may also harm the reputation of the company or product identified on the label. In some circumstances, the refilling of a bottle may be prohibited by the purchaser because of concerns with contamination and cleanliness in their application. Thus, there a need for a table top dispenser that, upon disassembly, cannot be reassembled and that maintains recyclability of the bottle.

### SUMMARY

Exemplary embodiments of tabletop dispenser having reassembly prevention devices are disclosed herein. An exemplary dispenser includes a container that has a neck. The neck having an inside neck diameter. A pump, a closure and a reassembly prevention device are also included. The reassembly prevention device is located between the closure and the pump. The reassembly prevention device has one or more members having a biased position and an unbiased position. When the one or more members are in the biased position, the outside diameter of the one or more members is less than the inside diameter of the neck. When the one or more members are in the unbiased position, the outside diameter of the one or more members is greater than the inside diameter of the neck. When the dispenser is assembled and the pump and reassembly prevention member are secured to the bottle by the closure, the reassembly prevention device is positioned inside the container neck and the reassembly prevention device is in the biased condition. When the pump and the reassembly prevention member are removed from the container neck, the one or more members to move to the unbiased position.

Another exemplary tabletop dispenser includes a container that has a neck with an inside neck diameter, a pump, a closure and a reassembly prevention device. The reassembly prevention device is located between the closure and the pump. The reassembly prevention device has two or more petals. The two or more petals each have a lower end. When the dispenser is assembled and the pump and reassembly prevention member are secured to the bottle by the closure, the reassembly prevention device is positioned inside the container neck and the reassembly prevention device is in a first position and the lower end of the petals have a first outside diameter. Upon removing the pump and the reassembly prevention member from the container neck, the one or more members move to a second position and the lower end of the petals have a second outside diameter.

Another exemplary tabletop dispenser includes a container that has a neck with an inside neck diameter, a pump, a closure and a reassembly prevention device. The reassembly prevention device is located between the closure and the pump. The reassembly prevention device has two or more petals. The two or more petals each have a lower end and a deformation member. When the dispenser is assembled and the pump and reassembly prevention member are secured to the bottle by the closure, the reassembly prevention device is positioned inside the container neck and the reassembly prevention device is in a first position and the lower end of the petals have a first outside diameter. Upon removing the pump and the reassembly prevention member from the container neck, the one or more members move to a second position and the lower end of the petals have a second outside diameter.

Exemplary methodologies of providing a dispenser having a reassembly prevention device are also disclosed herein. An exemplary methodology includes providing a container that has a neck with an inside neck diameter, providing a pump having a closure and providing a reassembly prevention device. The exemplary methodology includes securing the reassembly prevention device to the pump and/or the closure. The reassembly prevention device has a first position and a second position. In the first position, at least a portion of the reassembly prevention device has an outside diameter that is less than the inside neck diameter. In the second position, the reassembly prevention device has and outside diameter that is greater than the inside diameter of the neck.

Another exemplary methodology of providing a dispenser having a reassembly prevention device includes providing a container that has a neck that has an inside neck diameter, providing a pump having a closure, and providing a reassembly prevention device. The methodology further includes inserting the reassembly prevention device into the neck of the container, securing the pump and closure to the neck of the container, and securing the reassembly prevention device to the pump and/or the closure. The reassembly prevention device has one or more defamation members. Inserting the pump into the reassembly prevention device causes at least a portion of the reassembly prevention device to move from a first position toward a second position. In the first position, at least a portion of the reassembly prevention device has an outside diameter that is less than the inside neck diameter and in the second position, the reassembly prevention device is biased outward.

Another exemplary tabletop dispenser includes a bottle comprising a reservoir for containing sanitizer, a neck having a diameter smaller than a diameter of the bottle, a nozzle and a pump. The pump includes a housing extending into the reservoir of the bottle. A pump outlet fluidly connected to the nozzle and a pump inlet is arranged between the pump and a bottom of the reservoir. A reassembly prevention device that prohibits assembly of the pump to the bottle after the pump is disassembled from the bottle is also included.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 is a perspective view of an exemplary table top dispenser;

FIG. 2 is an exploded view of the exemplary table top dispenser of FIG. 1;

FIG. 3 is a partial cross-sectional view of the exemplary table top dispenser of FIG. 1;

FIG. 4 is an exploded view of the exemplary table top dispenser of FIG. 1;

FIG. 5 is a partial cross-sectional view of the exemplary table top dispenser of FIG. 1 in a pre-assembly condition;

FIG. 6 is a partial cross-sectional view of the exemplary table top dispenser of FIG. 1 with the pump removed from and unable to be reassembled to the bottle;

FIG. 7 is a perspective view of an exemplary table top dispenser;

FIG. 8 is an exploded view of the exemplary table top dispenser of FIG. 7;

FIG. 9 is a partial cross-sectional view of the exemplary table top dispenser of FIG. 1;

FIG. 10 is a cross-sectional view of a reassembly prevention device installed in the bottle of the exemplary table top dispenser of FIG. 7;

FIG. 11 is a partial cross-sectional view of the exemplary table top dispenser of FIG. 7 with the pump removed from and unable to be reassembled to the bottle;

FIG. 12 is an exemplary methodology for providing a dispenser having a reassembly prevention device;

FIG. 13 as another exemplary methodology for providing a dispenser having a reassembly prevention device;

FIG. 14 is a perspective view of another exemplary sanitizer dispenser;

FIG. 15 is an exploded view of the exemplary sanitizer dispenser of FIG. 14;

FIG. 16 is a partial cross-sectional view of the exemplary sanitizer dispenser of FIG. 14;

FIG. 17 is an exploded view of the exemplary sanitizer dispenser of FIG. 14;

FIG. 18 is a partial cross-sectional view of the exemplary sanitizer dispenser of FIG. 14 in a pre-assembly condition;

FIG. 19 is a partial cross-sectional front view of the exemplary sanitizer dispenser of FIG. 14 with the pump removed from and unable to be reassembled to the bottle; and

FIG. 20 is a partial cross-sectional side view of the exemplary sanitizer dispenser of FIG. 14 with the pump removed from and unable to be reassembled to the bottle.

### DETAILED DESCRIPTION

The following description refers to the accompanying drawings, which illustrate specific embodiments of the present disclosure. Other embodiments having different structures and operation do not depart from the scope of the present disclosure.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Also as described herein, the terms “substantially” and “about” are defined as at least close to (and includes) a given value or state (preferably within 10% of, more preferably within 1% of, and most preferably within 0.1% of).

In addition, although exemplary embodiments may be described as being sanitizer dispensers, the inventive concepts disclosed herein may be applied to soap dispensers, lotion dispensers and the like.

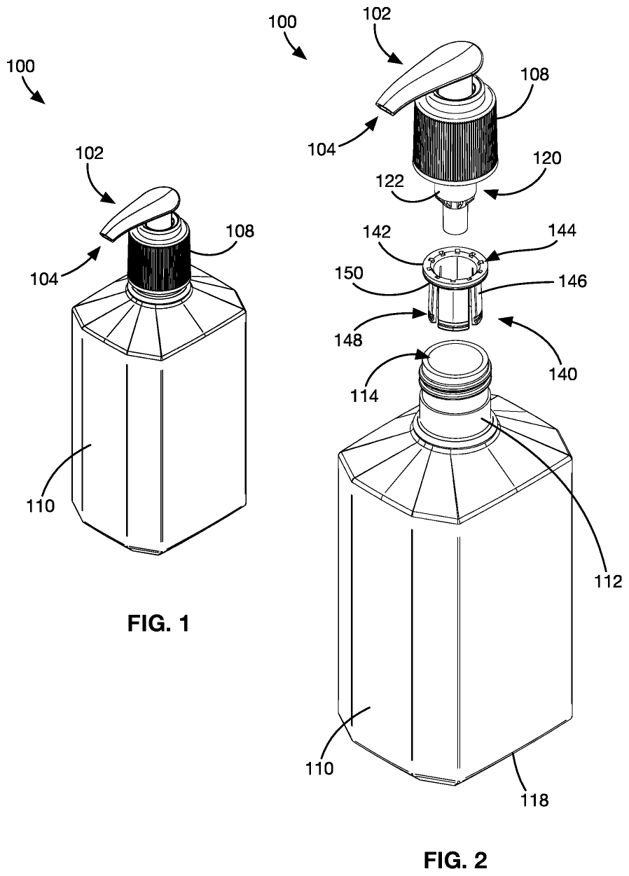

Referring now to FIGS. 1-6, illustrations of an exemplary dispenser 100 are shown. The dispenser 100 includes a nozzle 102 having a nozzle outlet 104. The nozzle 102 extends upward from a pump 120, forming a pump head 106. A fluid, such as, for example, hand sanitizer, is dispensed from the nozzle 102 when the pump head 106 is depressed by a user. The fluid is supplied to the nozzle 102 from a bottle 110 via a pump 120. The pump 120 is attached to the bottle 110 via a closure 108. The closure 108 attaches to a neck 112 of the bottle 110 after the bottle is filled with hand sanitizer. The connection between the closure 108 and the neck 112 can take on a wide variety of forms, such as, for example, a threaded connection, a quarter-turn connection, a snap connection, a barbed connection, a press fit connection, an adhesive connection, a welded connection, or any other suitable repeatable or permanent connection.

The neck 112 of the bottle 110 has a smaller diameter than the rest of the bottle 110 and includes a mouth or opening 114 that facilitates filling the bottle 110 with hand sanitizer. The bottle 110 encloses a reservoir 116 for holding the fluid, e.g. hand sanitizer, and has a bottom 118. The bottom 118 of the bottle 110 is shaped to provide improved stability when the bottle 110 is placed on a tabletop or other approximately horizontal surface. For example, in some embodiments, stability can be provided to the bottom via an indentation or concavity in the center of the bottom so that the surface area of the bottle that is in contact with the tabletop is arranged towards the outer perimeter of the bottle 110.

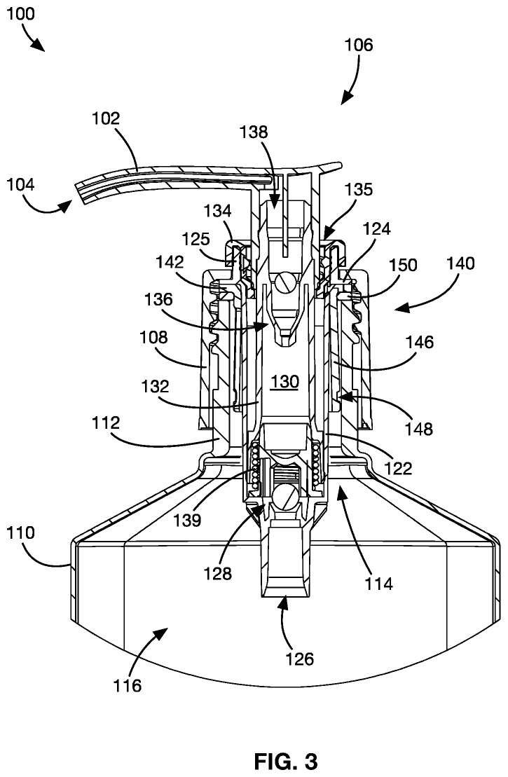

Referring now to FIG. 3, a cross-section view of the pump 120 attached to the bottle 110 is shown. A pump housing 122, which has a cylindrical shape in this exemplary embodiment, encloses the pump 120. The pump housing 122 includes a flange 124 that engages the neck 112 of the bottle 110 when the pump 120 is inserted into the mouth or opening 114 of the bottle 110. The closure 108 secures the flange 124 (FIG. 3) against the neck 112 of the bottle 110 to form a seal between the pump 120 and the bottle 110 to prohibit leakage of hand sanitizer from the reservoir 116. An optional gasket or seal can be inserted between the mouth 114 of the bottle 110 and the flange 124 of the pump 120 to prohibit leakage from the reservoir 116.

The pump housing 122 extends into the bottle 110 to a pump inlet 126 that can include an inlet tube (not shown) that extends to near the bottom of the reservoir 116. Providing an inlet tube that extends to the bottom of the reservoir 116 allows the dispenser 100 to dispense fluid from the reservoir 116 until the reservoir 116 is almost or completely empty, lengthening the time that the dispenser 100 can be used before it runs out and is disposed of or is refilled. Any suitable pump can be used to move fluid from the reservoir 116 to the nozzle outlet 104, such as, for example, a dome pump, a piston pump, a rotary pump, a gear pump, a sequentially activated multi-diaphragm pump, a liquid pump, a foam pump, or the like.

An inlet valve 128 is fluidly connected to the pump inlet 126 and a pump chamber 130. The pump chamber 130 is enclosed by the pump housing 122 and a piston 132. The pump housing 122 includes a cylindrical projection 125 that receives a collet 134. Collet 134 may be referred to herein as a housing cap or piston seal. The piston 132 extends upward through a pump housing cap or collet 134 attached to the upper end 125 of the pump housing 122. The pump housing cap or collet 134 can include a retaining portion 135 for retaining the pump head 106 in a compressed condition during shipment or storage of the dispenser 100 to prohibit unintentional actuation of the pump 120. The retaining portion 135 can take on a wide variety of forms, such as, for example, a threaded connection, a quarter-turn connection, a snap connection, or the like. The piston 132 is hollow and includes a pump outlet valve 136 that is in fluid communication with the pump chamber 130 and a pump outlet 138. The pump outlet 138 is connected to the pump head 106 and nozzle 102 to provide a fluid path from the pump chamber 130 to the nozzle outlet 104. The inlet valve 128 and the outlet valve 136 are both one-way valves: the inlet valve 128 allows flow from the reservoir 116 into the pump chamber 130 and prohibits flow out of the pump chamber 130; and the outlet valve 136 allows flow from the pump chamber 130 to the nozzle 102 and prohibits flow in the opposite direction.

During operation, the user presses down on the pump head 106 to move the piston 132 downward to compress the pump chamber 130 to the compressed position shown in FIG. 3. During compression of the pump chamber 130, the fluid pressure increases so that the inlet valve 128 closes and the outlet valve 136 opens, thereby allowing the contents of the pump chamber 130 to flow out of the outlet valve 136, through the nozzle 102 and nozzle outlet 104, and into the hand of the user. When force on the pump head 106 is released, a piston spring 139 pushes the piston 132 upward to expand the pump chamber 130. During expansion of the pump chamber 130, the pressure in the pump chamber 130 reduces so that the inlet valve 126 opens and the outlet valve 136 closes, thereby filling the pump chamber 130 with fluid from the reservoir 116 to charge the pump 120 for the next time a user wants to dispense hand sanitizer.

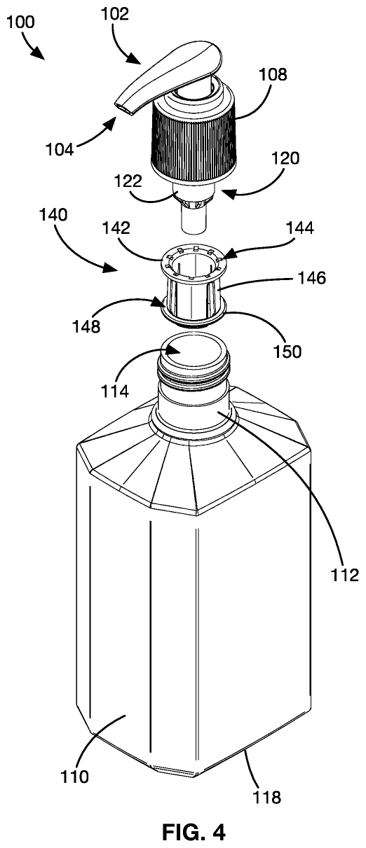

The dispenser 100 includes a reassembly prevention device 140, which may be called a or one-time assembly device. Reassembly prevention device 140 is located between the pump housing 122 and the neck 112 of the bottle 110. As can be more clearly seen in the exploded view of the dispenser 100 shown in FIG. 4, the reassembly prevention device 140 includes a flange 142 provided with optional radially spaced apart vent holes 144 to allow the bottle 110 to vent during operation of the pump 120. The flange 142 of the reassembly prevention device 140 is attached to the pump housing 122 to prohibit removal of the reassembly prevention device 140. The reassembly prevention device 140 can be attached to the pump housing 122 in a wide variety of ways, such as, for example, with a snap mechanism, a weld, an adhesive, a fastener, or the like.

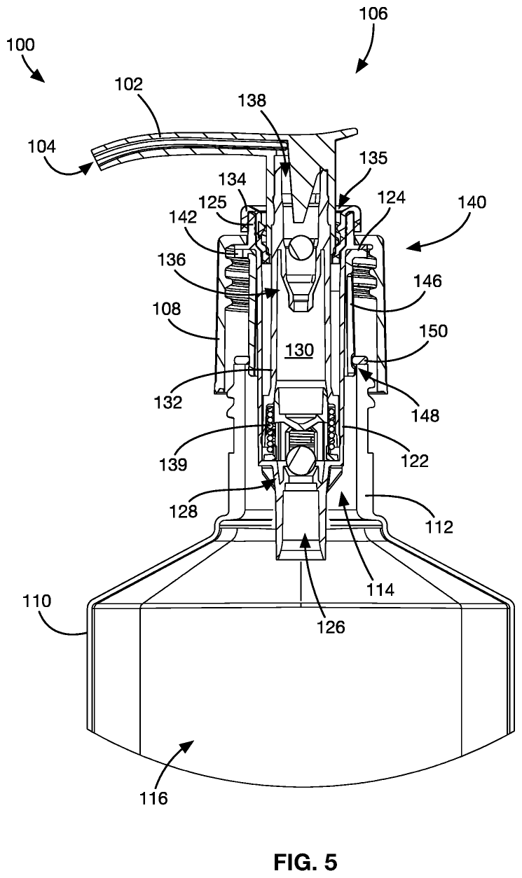

FIG. 5 shows the reassembly prevention device 140 attached to the pump 120 prior to assembly of the pump 120 to the bottle 110. Fingers or petals 146 extend downward from the flange 142. In some embodiments, the petals 146 also extend radially outward. In some embodiments, the petals 146 are biased outward.

An optional groove 148 is formed near a distal end of each of the petals 146 for receiving a retaining ring 150. The retaining ring 150 has an inside diameter that is approximately the same as the interior diameter to the flange 142. Because the petals 146 are biased outward, or extend outward, the petals 146 must be compressed radially inward to enable the retaining ring 150 moved over the ends of the petals 146 and into the grooves 148. The radially outward bias of the petals 146 presses the grooves 148 against the retaining ring 150, further securing the retaining ring 150 on the uninstalled reassembly prevention device 140.

The one or more petals 146 have a biased state and an unbiased state. In the biased state, the one or more petals 146 have an outside diameter, or an outside maximum distance, that is less than the inside diameter of the neck 112. In this exemplary embodiment, the one or more petals 146 are held in their biased state by retaining ring 150.

In some exemplary embodiments, the one or more petals 146 are held in place by a soluble retainer. The soluble retainer is selected to dissolve or break down when contacted with the fluid in the container. In such an embodiment, the pump and reassembly prevention device are inserted into the container. When the soluble retainer dissolves or breaks down due to contact with the fluid, the one or more petals are no longer held in their biased state.

The one or more petals 146 have an unbiased state. In the unbiased state, the one or more petals 146 have an outside diameter, or an outside maximum distance, that is greater than the inside diameter of the neck 112.

During assembly of the dispenser 100, the pump 120 is inserted into the mouth 114 of the bottle 110 and the closure 108 is tightened onto the neck 112 of the bottle 110 to secure the pump 120 to the bottle 110. As the pump 120 is inserted into the mouth 114 of the bottle 110, the retaining ring 150 engages the neck 112. Pressing the pump 120 further into the bottle 110 dislodges the retaining ring 150 from the grooves 148 of the petals 146 and slides the retaining ring 150 upward until the retaining ring 150 engages the flange 142 of the reassembly prevention device 140. Once the retaining ring 150 is moved upward, the petals 146 are free to move radially outward until the petals 146 engage the inner surface of the neck 112 of the bottle 110.

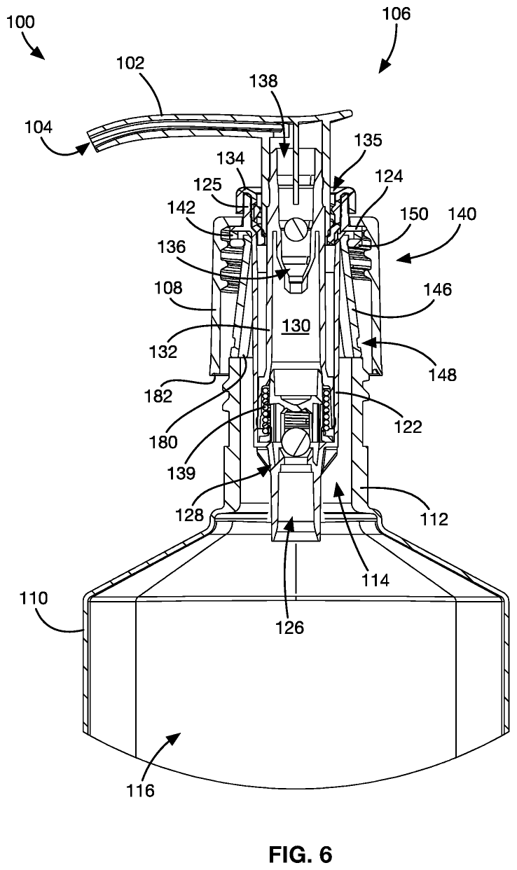

Referring now to FIG. 6, the pump 120 is shown being removed from the bottle 110. When the pump 120 is withdrawn from the neck 112 of the bottle 110 the petals 146 expand radially outward to a diameter that is wider than the opening of the mouth 114 of the bottle 110. The expanded petals 146 have a radius that is greater than the radius of the mouth 114 of the neck 112, which aids in prohibiting reinsertion of the pump 120 in the bottle 110.

In this exemplary embodiment, the lower petal surface 180 is located above the lower closure surface 182. Because the reassembly prevention device 140 is attached to the pump housing 122 at the flange 142, the petals 146, in their expanded position, are covered by the closure 108 and cannot be easily compressed to fit within the mouth 114 of the bottle 110, thereby preventing circumvention of the reassembly prevention device 140 without damage to the dispenser 100.

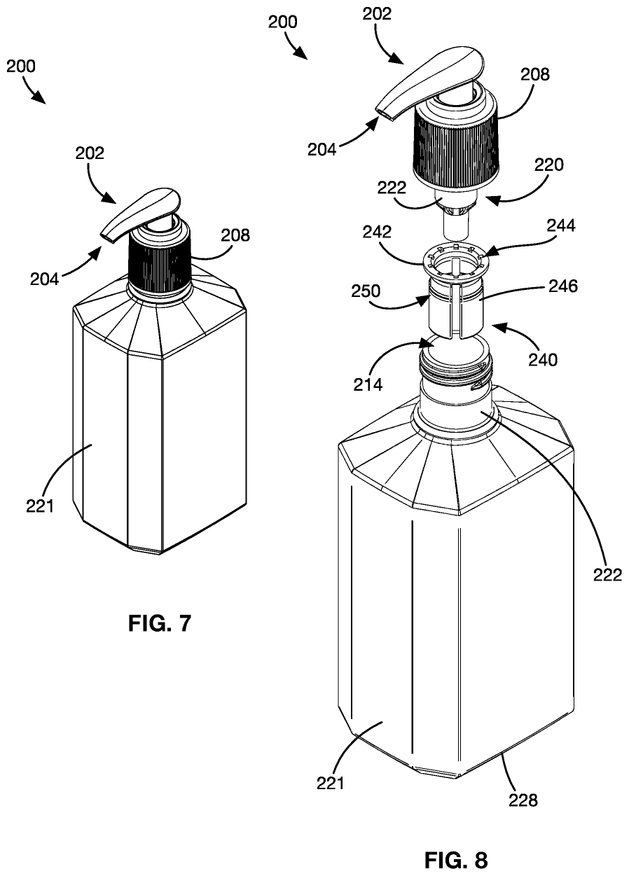

Referring now to FIGS. 7-11, illustrations of an exemplary dispenser 200 are shown. The dispenser 200 includes a nozzle 202 having a nozzle outlet 204, the nozzle 202 extends from pump 220 and forms a pump head 206. Fluid, such as, for example, hand sanitizer, is dispensed from the nozzle 202 when the pump head 206 is depressed by the user and is supplied to the nozzle 202 from a bottle 210 via a pump 220. The pump 220 is attached to the bottle 210 via a closure 208. The closure 208 attaches to a neck 212 of the bottle 210 after the bottle is filled with fluid. The connection between the closure 208 and the neck 212 can take on a wide variety of forms, such as, for example, a threaded connection, a quarter-turn connection, a snap connection, a barbed connection, a press fit connection, an adhesive connection, a welded connection, or any other suitable repeatable or permanent connection.

The neck 212 of the bottle 210 has a smaller diameter than the rest of the bottle 210 and includes a mouth or opening 214 that facilitates filling the bottle 210 with fluid. The bottle 210 encloses a reservoir 216 for holding the fluid, e.g. hand sanitizer, and has a bottom 218. The bottom 218 of the bottle 210 is shaped to provide improved stability when the bottle 210 is placed on a tabletop or other approximately horizontal surface. For example, stability can be provided to the bottom via an indentation or concavity in the center of the bottom so that the surface area of the bottle that is in contact with the tabletop is arranged towards the outer perimeter of the bottle 210.

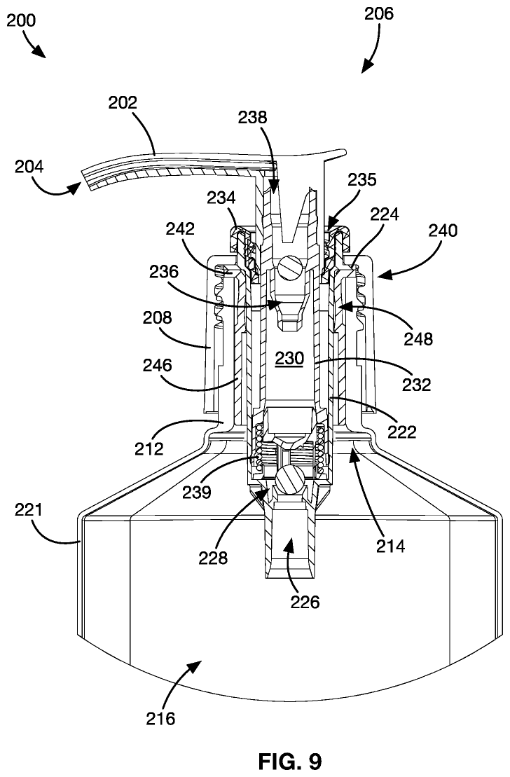

Referring now to FIG. 9, a cross-section view of the pump 220 attached to the bottle 210 is shown. A pump housing 222 encloses the pump 220 and a flange 224 of the pump housing 222 engages the neck 212 of the bottle 210 when the pump 220 is inserted into the mouth or opening 214 of the bottle 210. The closure 208 secures the flange 224 (FIG. 9) against the neck 212 of the bottle 210 to form a seal between the pump 220 and the bottle 210 to prohibit leakage of hand sanitizer from the reservoir 216. An optional gasket or seal can be inserted between the mouth 214 of the bottle 210 and the flange 224 of the pump 220 to prohibit leakage from the reservoir 216.

The pump housing 222 extends into the bottle 210 to a pump inlet 226 that can include an inlet tube (not shown) that extends to near the bottom of the reservoir 216 to allow the dispenser 200 to dispense hand sanitizer from the reservoir 216 until the reservoir 216 is almost or completely empty, lengthening the time that the dispenser 200 can be used before it runs out and is disposed of or is refilled. Any suitable pump can be used to move fluid from the reservoir 216 to the nozzle outlet 204, such as, for example, a dome pump, a piston pump, a rotary pump, a gear pump, a sequentially activated multi-diaphragm pump, a liquid pump, a foam pump, or the like.

An inlet valve 228 is fluidly connected to the pump inlet 226 and a pump chamber 230. The pump chamber 230 is enclosed by the pump housing 222 and a piston 232. The piston 232 extends upward through a pump closure 234, which may be referred to herein as a housing cap or piston seal, attached to the upper end of the pump housing 222. The closure 234 can include a retaining portion 235 for retaining the pump head 206 in a compressed condition during shipment or storage of the dispenser 200 to prohibit unintentional actuation of the pump 220. The retaining portion 235 can take on a wide variety of forms, such as, for example, a threaded connection, a quarter-turn connection, a snap connection, or the like. The piston 232 is hollow and includes an outlet valve 236 that is in fluid communication with the pump chamber 230 and a pump outlet 238. The pump outlet 238 is connected to the pump head 206 and nozzle 202 to provide a fluid path from the pump chamber 230 to the nozzle outlet 204. The inlet valve 228 and the outlet valve 236 are both one-way valves: the inlet valve 228 allows flow from the reservoir 216 into the pump chamber 230 and prohibits flow out of the pump chamber 230; and the outlet valve 236 allows flow from the pump chamber 230 to the nozzle 202 and prohibits flow in the opposite direction.

During operation, the user presses down on the pump head 206 to move the piston 232 downward to compress the pump chamber 230 to the compressed position shown in FIG. 3. During compression of the pump chamber 230, the fluid pressure increases so that the inlet valve 228 closes and the outlet valve 236 opens, thereby allowing the contents of the pump chamber 230 to flow out of the outlet valve 236, through the nozzle 202 and nozzle outlet 204, and into the hand of the user. When force on the pump head 206 is released, a piston spring 239 pushes the piston 232 upward to expand the pump chamber 230. During expansion of the pump chamber 230, the pressure in the pump chamber 230 reduces so that the inlet valve 228 opens and the outlet valve 236 closes, thereby filling the pump chamber 230 with fluid from the reservoir 216 to charge the pump 220 for the next time a user wants to dispense hand sanitizer.

The dispenser 200 includes a reassembly prevention or one-time assembly device 240 that is installed between the pump 220 and the neck 212 of the bottle 210. As can be more clearly seen in the exploded view of the dispenser 200 shown in FIG. 8, the reassembly prevention device 240 includes a flange 242. Flange 242 is optionally provided with radially spaced apart vent holes 244 to allow the bottle 210 to vent during operation of the pump 220.

The flange 242 of the reassembly prevention device 240 is attached to the pump housing 222 to prohibit removal of the reassembly prevention device 240. The reassembly prevention device 240 can be attached to the pump housing 222 in a wide variety of ways, such as, for example, with a snap mechanism, a weld, an adhesive, a fastener, or the like. In some embodiments, flange 242 is compressed between closure 208 and pump housing 222 to aid in retaining the reassembly prevention device 240 in place. The flange 242 (as well as flange 142) are optional and the reassembly prevention devices may be made without flanges, provided that the reassembly device is retained by the pump.

Fingers or petals 246 extend downward from the flange 242, each petal including an optional deformation portion 248. In some embodiments, the deformation portions 248 of the petals 246 are plastically deformed during assembly of the pump 220 to the bottle 210 to attach the reassembly prevention device 240.

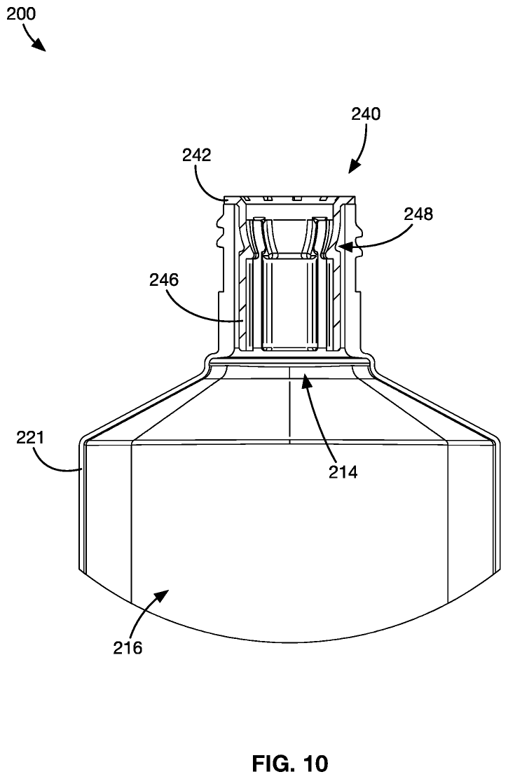

Referring now to FIG. 10, a cross-section view of the reassembly prevention device 240 is shown inserted in the mouth 214 of the bottle 210 prior to insertion of the pump 220 into the bottle 210. The deformation portions 248 of each petal 246 extend radially inward to a diameter that is less than the outer diameter of the pump housing 222. The deformation portions 248 can take on a wide variety of forms, such as the raised bead shown in FIG. 10, a knuckle portion, a rib portion, a barb portion, or any shape that can be deformed to secure the reassembly prevention device 240 to the pump housing 222.

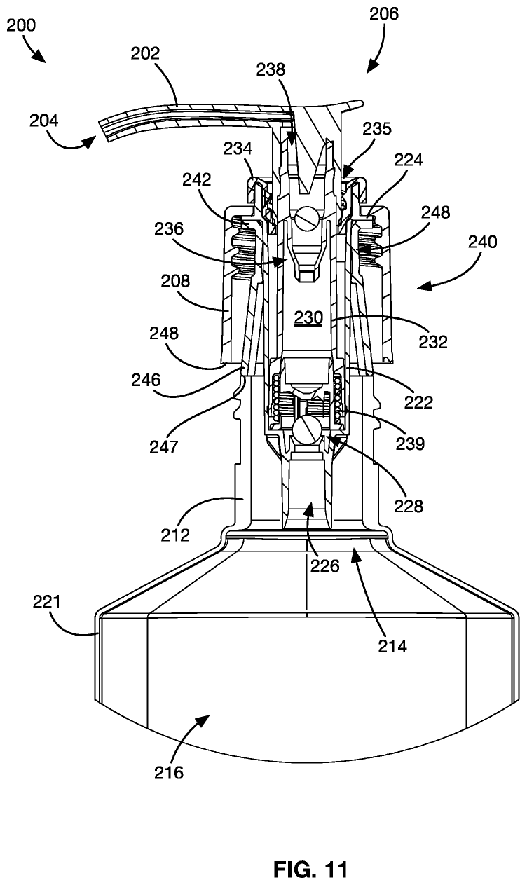

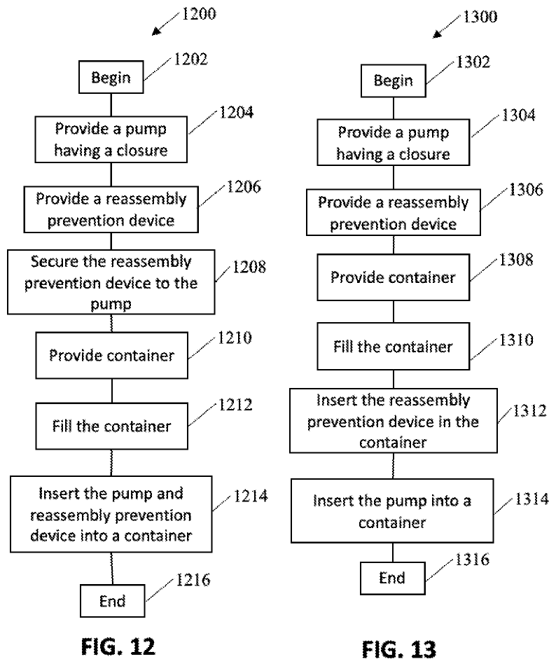

As the pump 220 is inserted through the reassembly prevention device 240 and into the mouth 214 of the bottle 221, the deformable portions or deformation portion 248 of the petals 246 are engaged and pressed outwards by the pump housing 222. The neck 212 of the bottle 210 restricts outward movement of the petals 246, thereby causing the deformation portions 248 to be squeezed between the neck 212 and the pump housing 222. As a result, the deformation portions 248 are plastically deformed and the reassembly prevention device 240 is attached to the pump 220. Compressing the deformation portions 248 also changes the shape of the petals 246 and biases the distal ends 247 of the petals 246 in a radially outward direction. Consequently, as is shown in FIG. 11, when the pump 220 is removed from the bottle 210 the petals 246 expand outward to a diameter that is larger than the mouth 214 of the bottle 210 to prohibit reassembly of the pump 220 to the bottle 210.

Thus, the ends of the one or more petals 246 have a biased state and an unbiased state. In the biased state, the one or more petals 246 have an outside diameter, or an outside maximum distance, that is less than the inside diameter of the neck 212. In this exemplary embodiment, the one or more petals 246 are held in their biased state by the inside of neck 212.

The ends of the one or more petals 246 have an unbiased state. In the unbiased state, the one or more petals 246 have an outside diameter, or an outside maximum distance, that is greater than the inside diameter of the neck 212. The one or more petals 246 are in their unbiased state when the reassembly prevention device is installed on the pump and removed from the neck 212.

In addition, when closure 208 is tightened down to the neck, flange 242 is compressed between closure 208 and pump housing 220. This compression fit secures reassembly prevention device 240 within closure 208 and the reassembly prevention device 240 will be removed when pump 220 and closure 208 are removed from bottle 221. In some embodiments, a rib (not shown) on the inside of closure 208 catches flange 242 to help retain reassembly prevention device 240 within closure 208.

In some embodiments, the petals 246 have a lower petal end 247 that is higher than the lower closure end 248. In such embodiments, the reassembly prevention device 240 is attached to the pump housing 222, the petals 246 in their expanded position are covered by the closure 208 and cannot be easily compressed and fit within the mouth 214 of the bottle 210. Thus, preventing circumvention of the reassembly prevention device 240 without damage to the dispenser 200.

In some embodiments, if reassembly prevention device140 or reassembly prevention device 240 contains the optional vent 144, 244 that are used to vent the container, and the reassembly prevention device140 or reassembly prevention device 240 is removes and discarded, the bottle or container will not vent as liquid and the dispenser will stop working.

Exemplary methodologies for preventing reassembly of dispensers are disclosed herein. The exemplary methodologies may be performed in other orders. Portions of one exemplary methodologies may be combined with all or portions of other exemplary methodologies. Additional blocks may be included and/or some blocks may be eliminated from the exemplary methodologies. In addition, unless otherwise noted, the order that the blocks are performed may be changed.

An exemplary methodology 1200 for providing a dispenser having a non-reassembly feature is disclosed herein. The exemplary methodology begins at block 1202. At block 1204 a pump having a closure is provided.

In addition, at block 1206 a reassembly prevention device is provided. The reassembly device incudes a one or more members that are biased outward. The one or more members have a biased state and an unbiased state. In the biased state, the one or more members have outside diameter that is less than the inside diameter of a neck of a container. As used herein, outside diameter does not mean that the one or more members must have a circular or partial cross-section, but merely means that the one or more members deflect to fit within the inside diameter of the container neck. The one or more members also have an unbiased state. In their unbiased state, the outside diameter of the one or more members is greater than the inside diameter of the container neck. The reassembly prevention device is secured to at least one of a pump and a pump closure at block 1208. Preferably the pump closure extends below the bottom of the reassembly prevention device.

At block 1210, a container is provided. the container has a container neck. At block 1212, the container is filled with fluid, such as, for example, a hand sanitizer. At block 1214, the pump and reassembly prevention device is inserted into the container, and the methodology ends at block 1216.

Another exemplary methodology 1300 for providing a dispenser having a non-reassembly feature is disclosed herein. The exemplary methodology begins at block 1302. At block 1304 a pump having a closure is provided. In addition, at block 1306 a reassembly prevention device is provided. The reassembly prevention device incudes a one or more members that are biased outward. The one or more members have a biased state and an unbiased state. In the biased state, the one or more members have outside diameter that is less than the inside diameter of a neck of a container. As used herein, outside diameter does not mean that the one or more members have a circular cross-section, but merely means that they deflect to fit within the inside diameter of the container neck.

The one or more members have an unbiased state. In their unbiased state, the outside diameter of the one or more members is greater than the inside diameter of the container neck. The reassembly prevention device is secured to at least one of a pump and a pump closure. Preferably the pump closure extends below the bottom of the reassembly prevention device.

At block 1308, a container is provided. The container has a container neck. At block 1310, the container is filled with fluid, such as, for example, a hand sanitizer. At block 1312, the reassembly prevention device is inserted into the neck of the container. At block 1314, the pump is inserted in the neck of the container and through the reassembly prevention device. The methodology ends at block 1216.

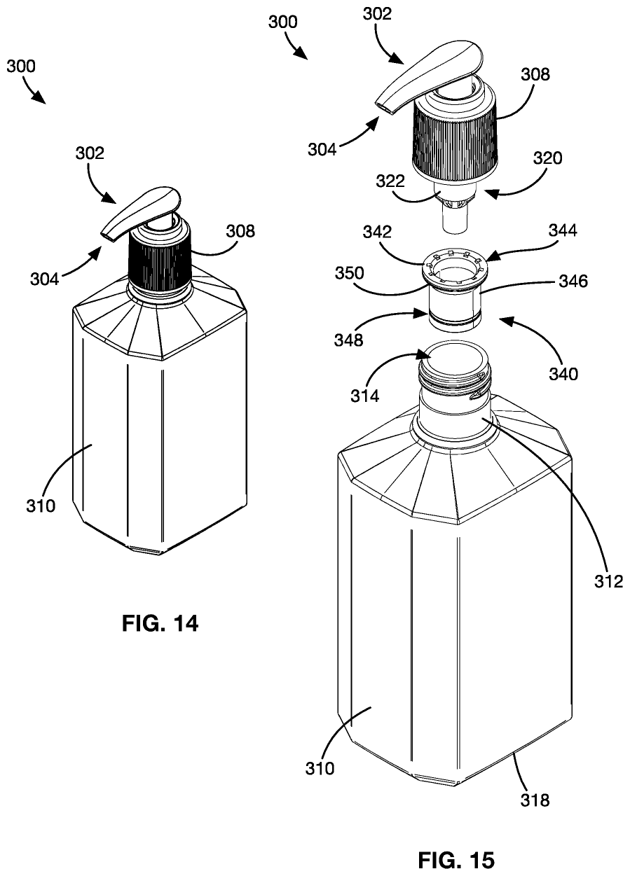

Referring now to FIGS. 14-20, illustrations of an exemplary dispenser 300 are shown. The dispenser 300 includes a nozzle 302 having a nozzle outlet 304. The nozzle 302 extends upward from a pump 320, forming a pump head 306. A fluid, such as, for example, hand sanitizer, is dispensed from the nozzle 302 when the pump head 306 is depressed by a user. The fluid is supplied to the nozzle 302 from a bottle 310 via a pump 320. The pump 320 is attached to the bottle 310 via a closure 308. The closure 308 attaches to a neck 312 of the bottle 310 after the bottle is filled with hand sanitizer. The connection between the closure 308 and the neck 312 can take on a wide variety of forms, such as, for example, a threaded connection, a quarter-turn connection, a snap connection, a barbed connection, a press fit connection, an adhesive connection, a welded connection, or any other suitable repeatable or permanent connection.

The neck 312 of the bottle 310 has a smaller diameter than the rest of the bottle 310 and includes a mouth or opening 314 that facilitates filling the bottle 310 with hand sanitizer. The bottle 310 encloses a reservoir 316 for holding the fluid, e.g. hand sanitizer, and has a bottom 318. The bottom 318 of the bottle 310 is shaped to provide improved stability when the bottle 310 is placed on a tabletop or other approximately horizontal surface. For example, in some embodiments, stability can be provided to the bottom via an indentation or concavity in the center of the bottom so that the surface area of the bottle that is in contact with the tabletop is arranged towards the outer perimeter of the bottle 310.

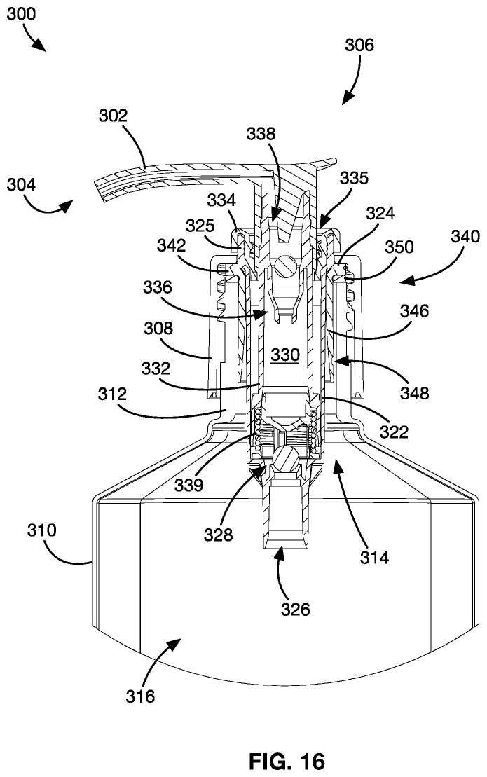

Referring now to FIG. 16, a cross-section view of the pump 320 attached to the bottle 310 is shown. A pump housing 322, which has a cylindrical shape in this exemplary embodiment, encloses the pump 320. The pump housing 322 includes a flange 324 that engages the neck 312 of the bottle 310 when the pump 320 is inserted into the mouth or opening 314 of the bottle 310. The closure 308 secures the flange 324 (FIG. 16) against the neck 312 of the bottle 310 to form a seal between the pump 320 and the bottle 310 to prohibit leakage of hand sanitizer from the reservoir 316. An optional gasket or seal can be inserted between the mouth 314 of the bottle 310 and the flange 324 of the pump 320 to prohibit leakage from the reservoir 316.

The pump housing 322 extends into the bottle 310 to a pump inlet 326 that can include an inlet tube (not shown) that extends to near the bottom of the reservoir 316. Providing an inlet tube that extends to the bottom of the reservoir 316 allows the dispenser 300 to dispense fluid from the reservoir 316 until the reservoir 316 is almost or completely empty, lengthening the time that the dispenser 300 can be used before it runs out and is disposed of or is refilled. Any suitable pump can be used to move fluid from the reservoir 316 to the nozzle outlet 304, such as, for example, a dome pump, a piston pump, a rotary pump, a gear pump, a sequentially activated multi-diaphragm pump, a liquid pump, a foam pump, or the like.

An inlet valve 328 is fluidly connected to the pump inlet 326 and a pump chamber 330. The pump chamber 330 is enclosed by the pump housing 322 and a piston 332. The pump housing 322 includes a cylindrical projection 325 that receives a collet 334. Collet 334 may be referred to herein as a housing cap or piston seal. The piston 332 extends upward through a pump housing cap or collet 334 attached to the upper end 325 of the pump housing 322. The pump housing cap or collet 334 can include a retaining portion 335 for retaining the pump head 306 in a compressed condition during shipment or storage of the dispenser 300 to prohibit unintentional actuation of the pump 320. The retaining portion 335 can take on a wide variety of forms, such as, for example, a threaded connection, a quarter-turn connection, a snap connection, or the like. The piston 332 is hollow and includes a pump outlet valve 336 that is in fluid communication with the pump chamber 330 and a pump outlet 338. The pump outlet 338 is connected to the pump head 306 and nozzle 302 to provide a fluid path from the pump chamber 330 to the nozzle outlet 304. The inlet valve 328 and the outlet valve 336 are both one-way valves: the inlet valve 328 allows flow from the reservoir 316 into the pump chamber 330 and prohibits flow out of the pump chamber 330; and the outlet valve 336 allows flow from the pump chamber 330 to the nozzle 302 and prohibits flow in the opposite direction.

During operation, the user presses down on the pump head 306 to move the piston 332 downward to compress the pump chamber 330 to the compressed position shown in FIG. 16. During compression of the pump chamber 330, the fluid pressure increases so that the inlet valve 328 closes and the outlet valve 336 opens, thereby allowing the contents of the pump chamber 330 to flow out of the outlet valve 336, through the nozzle 302 and nozzle outlet 304, and into the hand of the user. When force on the pump head 306 is released, a piston spring 339 pushes the piston 332 upward to expand the pump chamber 330. During expansion of the pump chamber 330, the pressure in the pump chamber 330 reduces so that the inlet valve 326 opens and the outlet valve 336 closes, thereby filling the pump chamber 330 with fluid from the reservoir 316 to charge the pump 320 for the next time a user wants to dispense hand sanitizer.

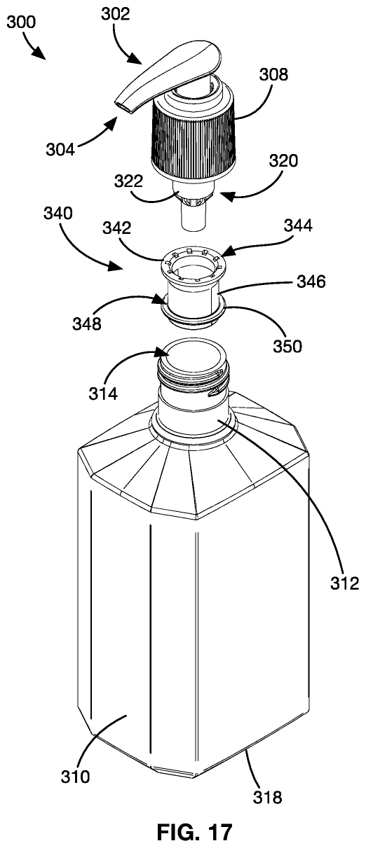

The dispenser 300 includes a reassembly prevention device 340, which may be called a or one-time assembly device. Reassembly prevention device 340 is located between the pump housing 322 and the neck 312 of the bottle 310. As can be more clearly seen in the exploded views of the dispenser 300 shown in FIGS. 15 and 17, the reassembly prevention device 340 includes a flange 342 provided with optional radially spaced apart vent holes 344 to allow the bottle 310 to vent during operation of the pump 320. The flange 342 of the reassembly prevention device 340 is attached to the pump housing 322 to prohibit removal of the reassembly prevention device 340. The reassembly prevention device 340 can be attached to the pump housing 322 in a wide variety of ways, such as, for example, with a snap mechanism, a weld, an adhesive, a fastener, or the like. In FIG. 15, the retaining ring 350 is shown at the top of sleeve 346 and in FIG. 17, the retaining ring 350 is shown in groove 348.

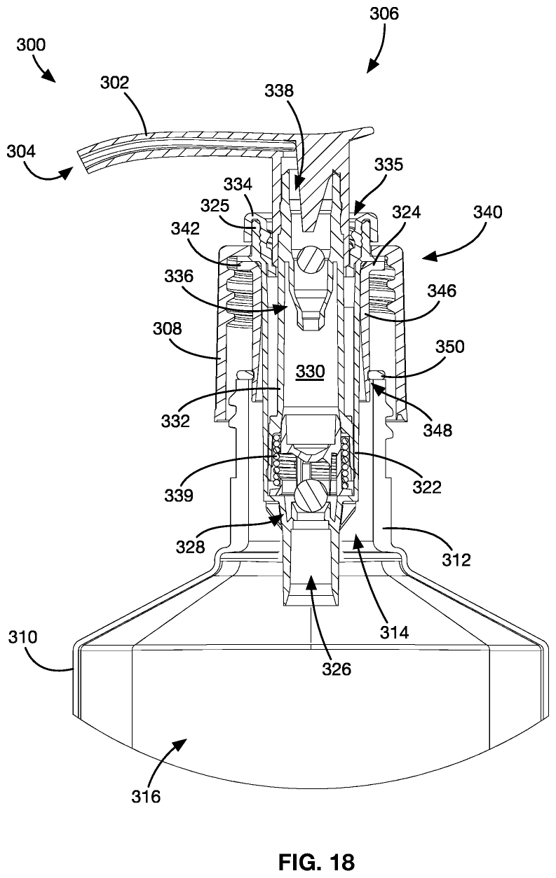

FIG. 18 shows the reassembly prevention device 340 attached to the pump 320 prior to assembly of the pump 320 to the bottle 310. A sleeve 346 having an elongated or oval-shaped cross-section extends downward from the flange 342. In some embodiments, the sleeve 346 also expand radially outward.

An optional groove 348 is formed near a distal end of the sleeve 346 for receiving a retaining ring 350. The retaining ring 350 has an inside diameter that is approximately the same as the interior diameter to the flange 342. Because the sleeve 346 has an elongated or oval-shaped cross-section, the sleeve 346 must be compressed inward along the major axis to enable the retaining ring 350 to be moved over the end of the sleeve 346 and into the groove 348. The outward bias of the sleeve 346 presses the groove 348 against the retaining ring 350, further securing the retaining ring 350 on the uninstalled reassembly prevention device 340.

The sleeve 346 has an unbiased state and a biased state. In the biased state, the oval-shaped sleeve 346 is compressed to a substantially round shape that has an outer diameter, or an outside maximum distance, that is less than the inside diameter of the neck 312. In this exemplary embodiment, the sleeve 346 is held in the compressed or biased state by the retaining ring 350.

In some exemplary embodiments, the sleeve 346 is held in the compressed or biased state by a soluble retainer. The soluble retainer is selected to dissolve or break down when contacted with the fluid in the container. In such an embodiment, the pump and reassembly prevention device are inserted into the container. When the soluble retainer dissolves or breaks down due to contact with the fluid, the one or more petals are no longer held in their biased state.

The oval-shaped sleeve 346 has an uncompressed or unbiased state. In the uncompressed or unbiased state, the oval-shaped sleeve 346 has a major diameter, or an outside maximum distance, that is greater than the inside diameter of the neck 312.

During assembly of the dispenser 300, the pump 320 is inserted into the mouth 314 of the bottle 310 and the closure 308 is tightened onto the neck 312 of the bottle 310 to secure the pump 320 to the bottle 310. As the pump 320 is inserted into the mouth 314 of the bottle 310, the retaining ring 350 engages the neck 312. Pressing the pump 320 further into the bottle 310 dislodges the retaining ring 350 from the grooves 348 of the sleeve 346 and slides the retaining ring 350 upward until the retaining ring 350 engages the flange 342 of the reassembly prevention device 340. Once the retaining ring 350 is moved upward, the sleeve 346 is free expand radially outward until the sleeve 346 engages the inner surface of the neck 312 of the bottle 310.

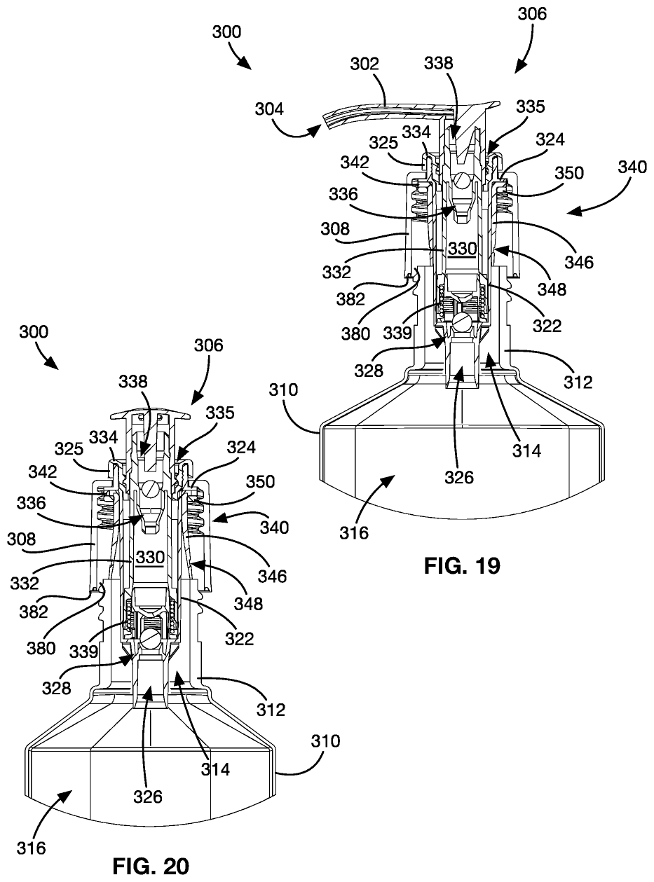

Referring now to FIGS. 19-20, the pump 320 is shown being removed from the bottle 310. When the pump 320 is withdrawn from the neck 312 of the bottle 310 the sleeve 346 expands outward to the unbiased oval-shape that has a major diameter that is wider than the opening of the mouth 314 of the bottle 310. The expanded sleeve 346 have a major radius that is greater than the radius of the mouth 314 of the neck 312, which aids in prohibiting reinsertion of the pump 320 in the bottle 310.

In this exemplary embodiment, the lower sleeve surface 380 is located above the lower closure surface 382. Because the reassembly prevention device 340 is attached to the pump housing 322 at the flange 342, in the expanded condition the sleeve 346 is covered by the closure 308 and cannot be easily compressed to fit within the mouth 314 of the bottle 310, thereby preventing circumvention of the reassembly prevention device 340 without damage to the dispenser 300.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed is:

1. A tabletop dispenser comprising:
a container;
the container having a neck;
the neck having an inside neck diameter;
a pump;
a closure; and
a reassembly prevention device;
the reassembly prevention device located between the closure and the pump;
the reassembly prevention device having
two or more petals;
wherein the two or more petals each have a lower end;
wherein when the dispenser is assembled and the pump and reassembly prevention member are secured to the bottle by the closure, the reassembly prevention device is positioned inside the container neck and the reassembly prevention device is in a first position and the lower end of the petals have a first outside diameter; and
wherein upon removing the pump and the reassembly prevention member from the container neck, the one or more members move to a second position and the lower end of the petals have a second outside diameter.

2. The table top dispenser of claim 1 wherein the reassembly prevention member further comprises a flange, and wherein the flange has an outside diameter that is greater than the inside diameter of the neck.

3. The table top dispenser of claim 2 wherein the flange comprises one or more air passages for venting the container.

4. The table top dispenser of claim 1 further comprise a retaining ring.

5. The table top dispenser of claim 4 wherein when the retaining ring is in a first position, the retaining ring retains the two or more petals in the biased position.

6. The table top dispenser of claim 5 wherein when the retaining ring is in a second position, the two or more petals are in the unbiased position.

7. The table top dispenser of claim 4 wherein the retaining ring has an outside diameter that is greater than the inside diameter of the neck.

8. The table top dispenser of claim 1 wherein the at least two petals comprise a groove.

9. The table top dispenser of claim 8 wherein when the retaining ring is located in the groove, the two or more petals are in the biased condition.

10. The table top dispenser of claim 1 wherein the closure extends below the end of the one or more members.

11. A tabletop dispenser comprising:
a container;
the container having a neck;
the neck having an inside neck diameter;
a pump;
a closure; and
a reassembly prevention device;
the reassembly prevention device located between the closure and the pump;
the reassembly prevention device having
two or more petals;
wherein the two or more petals each have a lower end;
wherein the two or more petals each have a deformation member;
wherein the deformation member contacts at least a portion of the pump, and wherein the deformation member causes an end of the two or more petals to be biased outward;
wherein when the dispenser is assembled and the pump and reassembly prevention member are secured to the bottle by the closure, the reassembly prevention device is positioned inside the container neck and the reassembly prevention device is in a first position and the lower end of the petals have a first outside diameter; and
wherein upon removing the pump and the reassembly prevention member from the container neck, the one or more members move to a second position and the lower end of the petals have a second outside diameter.

12. The table top dispenser of claim 11 wherein the reassembly prevention member further comprises a flange, and wherein the flange has an outside diameter that is greater than the inside diameter of the neck.

13. The table top dispenser of claim 12 wherein the flange comprises one or more air passages for venting the container.

14. The table top dispenser of claim 11 wherein the deformation member comprises a rib.

15. The table top dispenser of claim 11 wherein the deformation member comprises a projection.

16. The table top dispenser of claim 11 wherein the closure extends below the end of the one or more members.

17. A method of providing a dispenser having a reassembly prevention device comprising:
providing a container;
the container having a neck;
the neck having an inside neck diameter;
providing a pump having a closure;
providing a reassembly prevention device;
securing the reassembly prevention device to the pump and/or the closure;
wherein reassembly prevention device has a first position and a second position;
wherein in the first position, at least a portion of the reassembly prevention device has an outside diameter that is less than the inside neck diameter;
wherein in the second position, the reassembly prevention device has and outside diameter that is greater than the inside diameter of the neck.

18. The method of claim 17 further comprising inserting the pump and the reassembly prevention device in the neck of the container.

19. The method of claim 18 wherein inserting the pump and the reassembly prevention device in the neck of the container causes a retaining ring to move from a first position to a second position.

20. The method of claim 18 further comprising removing the pump from the container, wherein upon removal, the removal prevention device moves to the second position.
